(19) United States
(12) Patent Application Publication
(10) Pub. No.: US 2025/0198909 A1
(43) Pub. Date: Jun. 19, 2025

(54) Devices and Methods for Alignment Tools

(71) Applicant: IDEXX Laboratories, Inc., Westbrook, ME (US)

(72) Inventors: Spencer McElwain, Westbrook, ME (US); Caleb Niles, Westbrook, ME (US); Michael Moon, Westbrook, ME (US)

(21) Appl. No.: 18/962,899

(22) Filed: Nov. 27, 2024

Related U.S. Application Data
(60) Provisional application No. 63/610,671, filed on Dec. 15, 2023.

(51) Int. Cl. G01N 21/01

(52) U.S. Cl. CPC G01N 21/01; G01N 2021/0106

(57) ABSTRACT

A method of manufacturing a shimming device for engaging a plurality of surfaces is disclosed. In example embodiments, the method includes: (i) fabricating a first side of the shimming device, wherein the first side comprises: (a) a first plurality of pairs of coupled protrusions and (b) a first lower surface engaging portion; and (ii) fabricating a second side of the shimming device opposite the first side, wherein the second side comprises: (a) a second plurality of pairs of coupled protrusions and (b) a second lower surface engaging portion, wherein at least one pair of the first plurality of pairs of coupled protrusions engages a first surface of the plurality of surfaces when the second lower surface engaging portion engages a second surface of the plurality of surfaces.

### CROSS-REFERENCE TO RELATED APPLICATIONS

This application claims the benefit of co-pending U.S. Provisional Patent Application Ser. No. 63/610,671, filed Dec. 15, 2023 which is hereby incorporated by reference in its entirety.

### FIELD OF THE DISCLOSURE

The present disclosure involves systems and methods for alignment tools (e.g., shimming devices) for aligning components of one or more machines (e.g., an imaging device) while analyzing samples (e.g., biological samples). Namely, devices and methods of the disclosure align and stabilize components of an imaging device to ensure proper alignment (e.g., tip and tilt alignment) prior to imaging events by the imaging device.

### SUMMARY

In an example, a shimming device is described that comprises a first side comprising a first plurality of pairs of coupled protrusions and a first lower surface engaging portion, wherein the first lower surface engaging portion is disposed between at least one pair of coupled protrusions of the first plurality of pairs of coupled protrusions. The shimming device also comprises a second side opposite the first side comprising a second plurality of pairs of coupled protrusions and a second lower surface engaging portion, wherein the second lower surface engaging portion is disposed between at least one pair of coupled protrusions of the second plurality of pairs of coupled protrusions, and wherein at least one pair of the first plurality of pairs of coupled protrusions engages a first surface of the plurality of surfaces when the second lower surface engaging portion engages a second surface of the plurality of surfaces.

In an example, a shimming device is described that comprises a first side comprising a first plurality of pairs of coupled protrusions and a first lower surface engaging portion, wherein the first lower surface engaging portion is disposed between at least one respective pair of coupled protrusions of the first plurality of pairs of coupled protrusions. The shimming device also comprises a second side opposite the first side comprising a second plurality of pairs of coupled protrusions and a second lower surface engaging portion, wherein the second lower surface engaging portion is disposed between at least one pair of coupled protrusions of the second plurality of pairs of coupled protrusions, and wherein at least one pair of the first plurality of pairs of coupled protrusions engages a first surface of the plurality of surfaces when the second lower surface engaging portion engages a second surface of the plurality of surfaces, and wherein, when the shimming device is inverted, at least one pair of the second plurality of pairs of coupled protrusions engages the first surface of the plurality of surfaces when the first lower surface engaging portion engages the second surface of the plurality of surfaces.

In another example, a method of manufacturing a shimming device for engaging a plurality of surfaces is described. In an example, the method comprises fabricating a first side of the shimming device, wherein the first side comprises a first plurality of pairs of coupled protrusions and a first lower surface engaging portion, wherein the first lower surface engaging portion is disposed between at least one pair of coupled protrusions of the first plurality of pairs of coupled protrusions. The method also describes fabricating a second side of the shimming device opposite the first side, wherein the second side comprises a second plurality of pairs of coupled protrusions and a second lower surface engaging portion, wherein the second lower surface engaging portion is disposed between at least one pair of coupled protrusions of the second plurality of pairs of coupled protrusions, and wherein at least one pair of the first plurality of pairs of coupled protrusions engages a first surface of the plurality of surfaces when the second lower surface engaging portion engages a second surface of the plurality of surfaces.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional, features will be better understood through the following illustrative and non-limiting detailed description of example embodiments, with reference to the appended drawings.

FIG. 1A illustrates an isometric view of an example shimming device, according to an example embodiment.

FIG. 1B illustrates an isometric view of the example shimming device of FIG. 1A, according to an example embodiment.

FIG. 1C illustrates an environmental view of the example shimming device of FIGS. 1A-1B in an example operating environment, according to an example embodiment.

FIG. 1D illustrates a side view of the example shimming device of FIGS. 1A-1C, according to an example embodiment.

FIG. 1E illustrates a side view of the example shimming device of FIGS. 1A-1D, according to an example embodiment.

FIG. 1F illustrates a side view of the example shimming device of FIGS. 1A-1E, according to an example embodiment.

FIG. 2A illustrates an isometric view of an example shimming device, according to an example embodiment.

FIG. 2B illustrates an isometric view of the example shimming device of FIG. 2A, according to an example embodiment.

FIG. 2C illustrates a top view of the example shimming device of FIGS. 2A-2B, according to an example embodiment.

FIG. 2D illustrates a bottom view of the example shimming device of FIGS. 2A-2C, according to an example embodiment.

FIG. 2E illustrates a side view of the example shimming device of FIGS. 2A-2D, according to an example embodiment.

FIG. 2F illustrates a side view of the example shimming device of FIGS. 2A-2E, according to an example embodiment.

FIG. 3A illustrates an isometric view of an example shimming device, according to an example embodiment.

FIG. 3B illustrates an isometric view of the example shimming device of FIG. 3A, according to an example embodiment.

FIG. 4 illustrates a method, according to an example embodiment.

FIG. 5 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example.

In particular, one or more imaging devices may be used for testing and identification of components in a sample. To increase the accuracy of the imaging and any associated testing results, it is desirable to image the sample and/or solution in a consistent, reliable manner, according to a consistent protocol and, prior to imaging, ensure that the alignment of one or more components of the imaging devices is properly set. Current manufacturing constraints for these imaging devices also result in alignment issues, and current machining and fabrication techniques cannot address all of these alignments issues. These alignment issues are also cumulative and often lead to mechanical and/or imaging tolerance stacking.

Furthermore, when operators attempt to manually adjust these components to avoid these issues using existing technologies, the results of the alignment and any associated imaging may still be inconsistent and/or inaccurate, and may even vary operator to operator. For example, an operator's positioning and/or repositioning of one or more components of the imaging devices can significantly affect the type and consistency of images taken of the sample and/or solution. These inconsistency from one imaging event to another can also impact the accuracy and precision of other testing protocols (e.g., imaging and/or assay results). Accordingly, manual adjustments are subject to variability between imaging events and/or operators and, thus, degrade the accuracy and precision of any associated imaging.

To help address these issues, within examples, the disclosure is directed to devices and methods for shimming device for engaging a plurality of surfaces (e.g., of one or more components of the imaging device) to help improve the consistency of adjusting and/or otherwise aligning one or more components of an imaging device. By doing so, the results of the alignment and any associated imaging will improve, as will the consistency and accuracy of any associated images and/or test results. If a further aspect, by standardizing the protocol for aligning these components with a prefabricated shimming device, the consistency and accuracy of this alignment will also improve any potential variance operator to operator.

Additionally, devices and methods described herein can adjust one or more components of an imaging device such that the one or more components of the imaging device are at a consistent coordinate position, relative alignment, and/or orientation during the imaging event. To do so, in examples, a shimming device for engaging a plurality of surfaces is described.

In examples, the shimming device includes one or more pairs of coupled protrusions disposed along one or more sides of the shimming device. In one example, these pairs of coupled protrusions are disposed along two, opposing sides of the shimming device. In examples, these pairs of coupled protrusions may be arranged such that each pair of coupled protrusions of a first plurality of pairs of coupled protrusions (e.g., on a first side of the shimming device) is aligned with a respective pair of coupled protrusions of a second plurality of pairs of coupled protrusions (e.g., on a second side of the shimming device). In some examples, these pairs of coupled protrusions may be arranged as one or more pairs of coupled steps. In some examples, each pair of coupled steps may be a different height from a longitudinal axis of the shimming device. In some examples, the shimming device may contain pairs of coupled steps on multiple sides of the shimming device. For example, in some embodiments, the shimming device may contain pairs of coupled steps on a first side and pairs of coupled steps on a second side. Each of these pairs of coupled steps may be a different height from a longitudinal axis of the shimming device on their respective sides, but the same height as compared to a corresponding pair of coupled steps that are aligned with the pair of coupled steps on the opposing side. Other examples are possible.

In some examples, these protrusions may take one or more specific shapes, dimensions, and/or particular arrangements. For example, in some embodiments, these protrusions may be one or more specific shapes, including one or more of the following shapes: a square shape, a rectangular shape, a conical shape, a triangular shape, a semi-rounded shape, a cylindrical shape, a spherical shape, and/or a semi-spherical shape, among other possibilities. For example, in some embodiments, the surface of these protrusions that engages the one or more surfaces of a device (e.g., a component surface of an imaging device) may be one or more specific shapes, including one or more of the following shapes: flat, substantially flat, semi-flat, rectangular, conical, rounded, semi-rounded, a cylindrical, and/or triangular, among other possibilities.

In examples, the shimming device includes one or more lower surface engaging portions disposed along one or more sides of the shimming device. In one example, these lower surface engaging portions are disposed along two, opposing sides of the shimming device. In examples, these lower surface engaging portions may be arranged such that each lower surface engaging portion of a first plurality of lower surface engaging portions (e.g., on a first side of the shimming device) is aligned with a respective lower surface engaging portion of a second plurality of lower surface engaging portions (e.g., on a second side of the shimming device). In some embodiments, one or more of these lower surface engaging portions may be disposed between a respective pair of coupled protrusions. In some examples, these lower surface engaging portions may be arranged such that each lower surface engaging portion is disposed between as one or more pairs of coupled steps. In some examples, each lower surface engaging portion may be a same height from a longitudinal axis of the shimming device. In some examples, each lower surface engaging portion may be a different height from a longitudinal axis of the shimming device. In some examples, the shimming device may contain lower surface engaging portions disposed between pairs of coupled steps on multiple sides of the shimming device. For example, in some embodiments, the shimming device may contain a first plurality of lower surface engaging portions disposed between pairs of coupled steps on a first side and a second plurality of lower surface engaging portions disposed between pairs of coupled steps on a second side. Each of these a lower surface engaging portions may be a same height from a longitudinal axis of the shimming device on their respective sides, but a different height as compared to a corresponding lower surface engaging portions that are aligned with the corresponding plurality of lower surface engaging portions on the opposing side. Other examples are possible.

In some examples, these lower surface engaging portions may take one or more specific shapes, dimensions, and/or particular arrangements. For example, in some embodiments, these lower surface engaging portions may be one or more specific shapes, including one or more of the following shapes: a square shape, a rectangular shape, a conical shape, a triangular shape, a semi-rounded shape, a cylindrical shape, a spherical shape, and/or a semi-spherical shape, among other possibilities. In a further aspect, the lower surface engaging portions may be a single shape and/or structure on one or more sides of the shimming device. In a further aspect, in some embodiments, the surface of these lower surface engaging portions that engages the one or more surfaces of a device (e.g., a component surface of an imaging device) may be one or more specific shapes, including one or more of the following shapes: flat, substantially flat, semi-flat, rectangular, conical, rounded, semi-rounded, a cylindrical, and/or triangular, among other possibilities. In a further aspect, the lower surface engaging portions may be a single surface on one or more sides of the shimming device. Other examples are possible.

In examples, the shimming device may be configured and/or otherwise fabricated so that at least one pair of a plurality of pairs of coupled protrusions engages a first surface of a plurality of surfaces (e.g., of a first component of the imaging device) when at least one lower surface engaging portion of a plurality of lower surface engaging portions engages a second surface of the plurality of surfaces (e.g., of a second component of the imaging device). For example, in embodiments, the shimming device may include a plurality of pairs of coupled protrusions on a first side of the shimming device and a plurality of lower surface engaging portions on a second, opposing side of the shimming device. In this embodiment, the shimming device may be configured and/or otherwise fabricated so that the at least one pair of the plurality of pairs of coupled protrusions on the first side engages a first surface of the plurality of surfaces when at least one lower surface engaging portion of the plurality of lower surface engaging portions engages a second surface of the plurality of surfaces. Other examples are possible.

For example, in embodiments, the shimming device may have a first side that includes a first plurality of pairs of coupled protrusions and a first plurality of lower surface engaging portions disposed between each pair of coupled protrusions of the first plurality of pairs of coupled protrusions, and a second side, opposite the first side, that includes a second plurality of pairs of coupled protrusions and a second plurality of lower surface engaging portions disposed between each pair of coupled protrusions of the second plurality of pairs of coupled protrusions. In this example embodiment, the shimming device may be configured and/or otherwise fabricated so that the at least one pair of the first plurality of pairs of coupled protrusions engages a first surface of a plurality of surfaces (e.g., of a first component of the imaging device) when at least one lower surface engaging portion of the second plurality of lower surface engaging portions engages a second surface of the plurality of surfaces (e.g., of a second component of the imaging device), and wherein, when the shimming device is inverted, at least one pair of the second plurality of pairs of coupled protrusions engages the first surface of the plurality of surfaces when at least one lower surface engaging portion of the first plurality of lower surface engaging portions engages the second surface of the plurality of surfaces. Other examples are possible.

In examples, the shimming device includes one or more spacer channels disposed along one or more sides of the shimming device. In one example, these one or more spacer channels are disposed along two, opposing sides of the shimming device. In examples, the shimming device includes a spacer channel disposed between each pair of coupled protrusions (e.g., between each pair of coupled steps). In other examples, the shimming device includes a spacer channel disposed between each lower surface engaging portion. In some examples, each of the lower surface engaging portions are disposed between a respective pair of coupled protrusions (e.g., steps) and a spacer channel is disposed between each pair of coupled protrusions and the corresponding lower surface engaging portion. In other examples, each of the lower surface engaging portions are disposed between a respective pair of coupled protrusions (e.g., steps) and a spacer channel is disposed between each pair of coupled protrusions, but not between any or all of the corresponding lower surface engaging portions (e.g., the lower surface engaging portion may be one solid surface along one side of the shimming device. Other examples are possible.

For example, in some embodiments, the shimming device includes one or more handles disposed along one or more sides of the shimming device. In one example, these one or more handles includes handle that is disposed on a side of the shimming device that does not include any pair of couple protrusion or lower surface engaging portion. In one example, these one or more handles includes a handle that is disposed on a side of the shimming device that does not include any pair of couple protrusions, but does include a lower surface engaging portion. In one example, these one or more handles includes a handle that is disposed on a side of the shimming device that includes a pair of couple protrusions, but not a lower surface engaging portion. In one example, these one or more handles includes handle that is disposed on a side of the shimming device that includes pairs of couple protrusions and a lower surface engaging portion. In examples, these one or more handles may integrate with one or more components of the imaging device. For example, the handle may be configured to interface with a fastener mechanism (e.g., a screw) of the imaging device. Other examples are possible.

For example, the shimming device include one or more indicators on one or more surfaces of the shimming device. For example, if the shimming device has two sides, the shimming device may include an indicator of the first side and/or the second side. In a further aspect, in example embodiments, the shimming device may include one or more indicators of a characteristics of one or more components of the shimming device, including one or more indicators of a characteristic of the one or more pairs of protrusions (e.g., height, shape, etc.). In examples, one or more of these indicators may be printed, etched, carved, embossed, and/or otherwise disposed one or more surfaces of the shimming device. Other examples are possible.

For example, the shimming device may be made of one or more materials, including: (i) metal alloys (including a stainless steel alloy); (ii) plastics; (iii) rubber; (iv) elemental metals; (v) ceramics; and (vi) metal composites, among other possibilities. Other examples are possible.

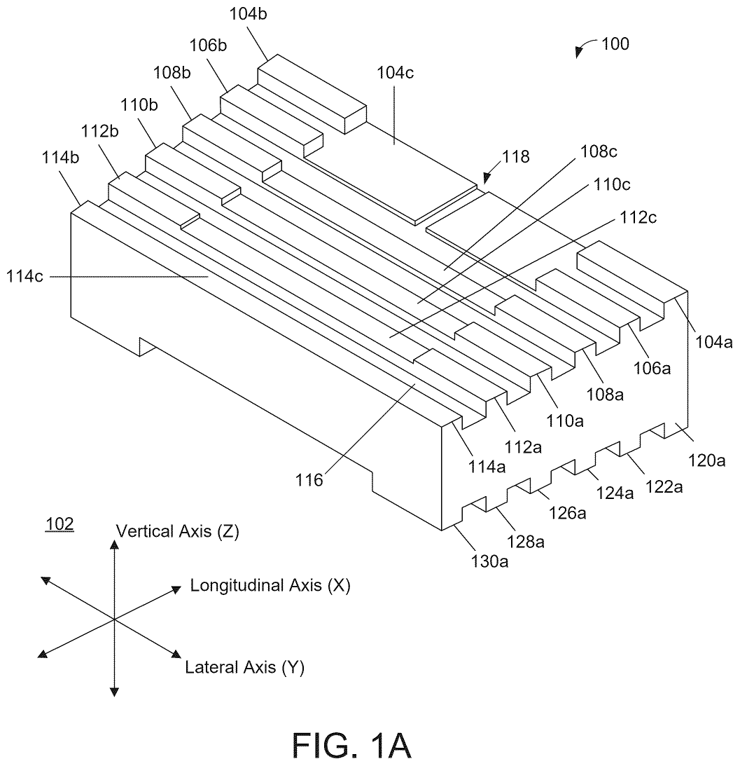

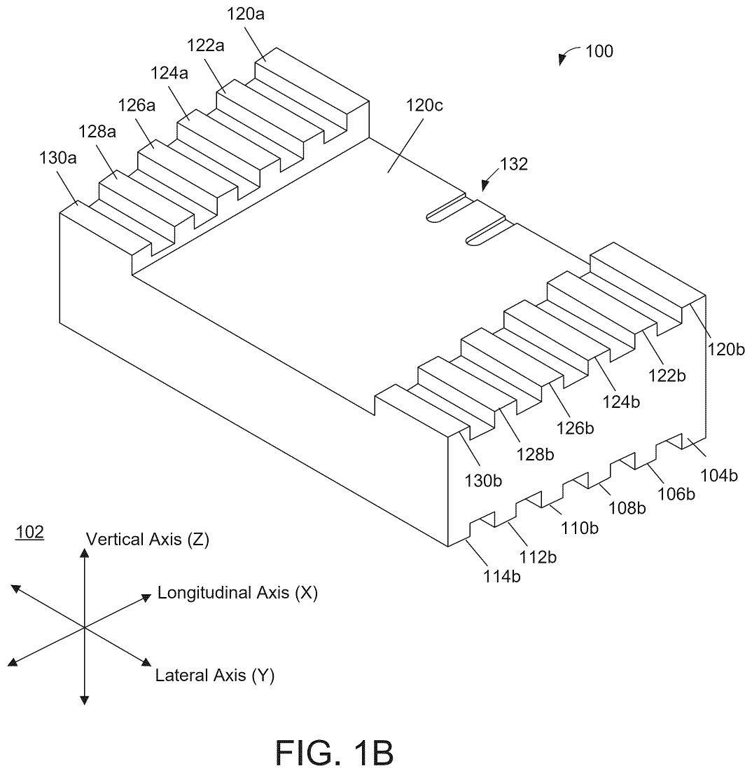

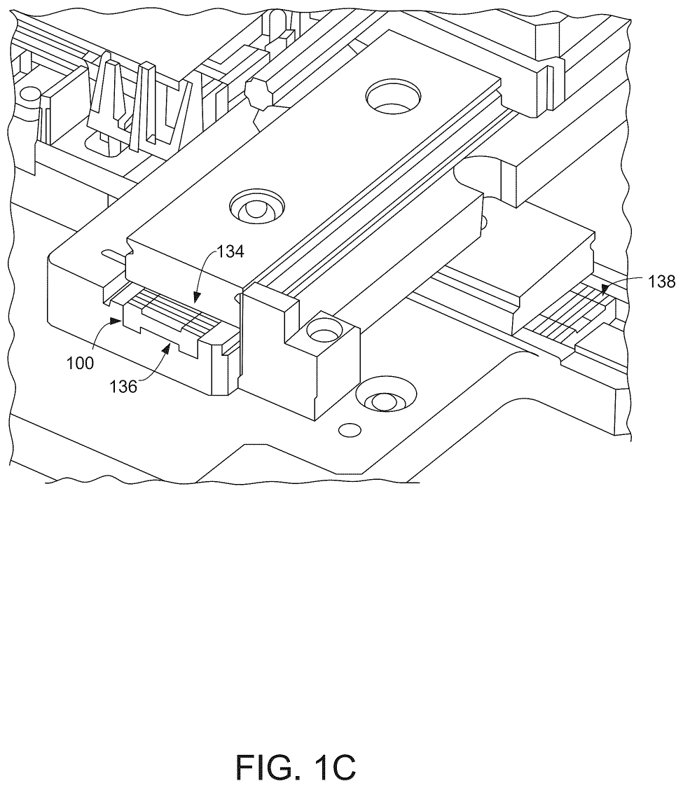

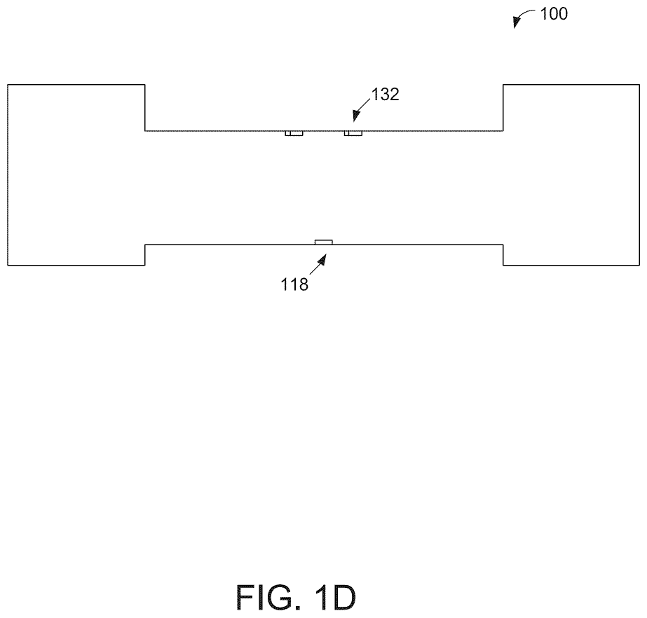

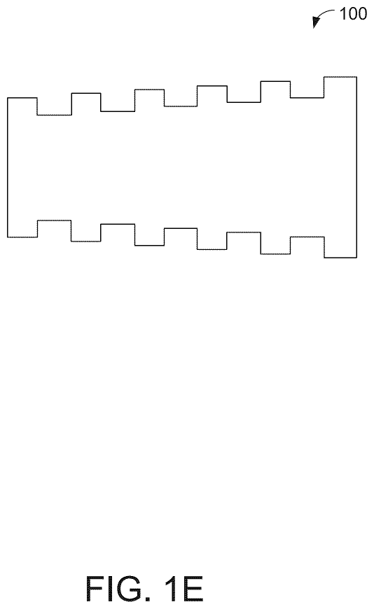

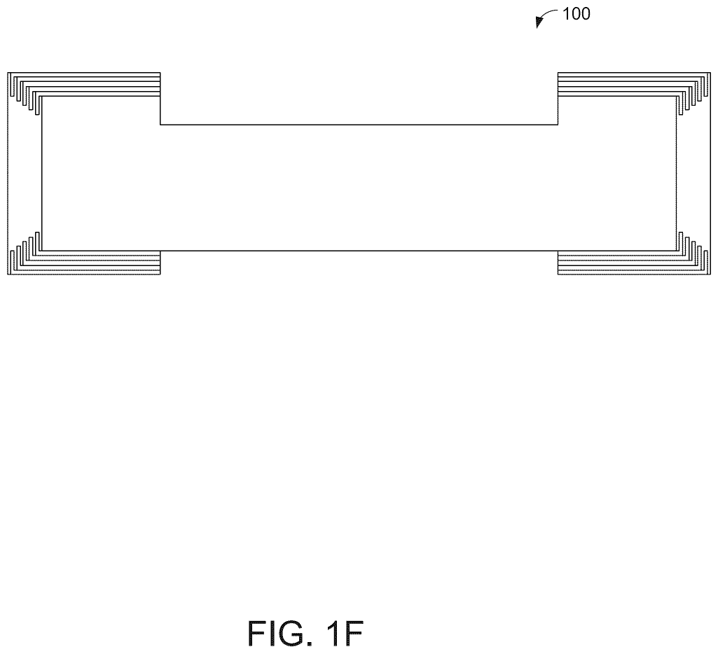

Now referring to the figures, FIGS. 1A-1F illustrate an example shimming device 100. As illustrated in FIG. 1A, an isometric view of shimming device 100 is illustrated, with the relative direction and orientation of the shimming device 100 defined by legend 102 (which illustrates a vertical axis (z), a longitudinal axis (x), and lateral axis (y)). As illustrated in FIG. 1A, in example embodiments, the shimming device 100 includes first pair of protrusions 104a and 104b, a second pair of protrusions 106a and 106b, a third pair of protrusions 108a and 108b, a fourth pair of protrusions 110a and 110b, a fifth pair of protrusions 112a and 112b, a sixth pair of protrusions 114a and 114b, a first lower surface engaging portion 104c (disposed between first pair of protrusions 104a and 104b, as well as second pair of protrusions 106a and 106b), a third lower surface engaging portion 108c (disposed between third pair of protrusions 108a and 108b), a fourth lower surface engaging portion 110c (disposed between fourth pair of protrusions 110a and 110b), a fifth lower surface engaging portion 112c (disposed between fifth pair of protrusions 112a and 112b), a sixth lower surface engaging portion 114c (disposed between sixth pair of protrusions 114a and 114b), a spacer channel 116, a first identifier 118, a first protrusion 120a of a seventh pair of protrusions, an first protrusion 122a of an eighth pair of protrusions, a first protrusion 124a of a ninth pair of protrusions, a first protrusion 126a of a tenth pair of protrusions, a first protrusion 180a of an eleventh pair of protrusions, and a first protrusion 130a of a twelfth pair of protrusions.

Furthermore, although the protrusions are illustrated as couple pairs in FIGS. 1A-1F, many other arrangements are possible, including: singlet protrusions, coupled triplets, coupled quadruplets, coupled quintuplets, and/or any combination thereof, among other possibilities. In a further aspect, although FIGS. 1A-1F illustrated twelve pairs of protrusions, more or less pairs of protrusions may be implemented, including two pairs of protrusions, three pairs of protrusions, four pairs of protrusions, five pairs of protrusions, six pairs of protrusions, seven pairs of protrusions, eight pairs of protrusions, nine pairs of protrusions, ten pairs of protrusions, eleven pairs of protrusions, thirteen pairs of protrusions, fourteen pairs of protrusions, fifteen pairs of protrusions, sixteen pairs of protrusions, seventeen pairs of protrusions, eighteen pairs of protrusions, nineteen pairs of protrusions, twenty pairs of protrusions, and so on.

In the example embodiment illustrated in FIG. 1A, a first side of the shimming device 100 (identified by first identifier 118) includes six pairs of coupled protrusions, each of which has a lower surface engaging portion disposed between the respective pairs of coupled protrusions. As shown in FIG. 1A, first lower surface engaging portion 104c is disposed between the first pair of protrusions 104a and 104b, as well as second pair of protrusions 106a and 106b. As also shown in FIG. 1A, the sixth lower surface engaging portion 114c is disposed between the sixth pair of protrusions 114a and 114b to make one solid contiguous surface across the sixth pair of protrusions 114a and 114b sixth lower surface engaging portion 114c. As also illustrated in FIG. 1A, a spacer channel 116 is shown as disposed between the fifth and sixth pairs of protrusions and their respective lower surface engaging portions. Although not specifically enumerated, additional space channels are illustrated in FIG. 1A between pairs of protrusions and their respective lower surface engaging portions and other pairs of protrusions and their respective lower surface engaging portions.

Furthermore, although the protrusions and their respective lower surface engaging portions are illustrated in a specific arrangement in FIG. 1A, many other arrangements are possible, including: lower surface engaging portions 108c, 110c and/or 112c may be arranged similar to lower surface engaging portion 104c, lower surface engaging portions 108c, 110c and/or 112c may be arranged similar to lower surface engaging portion 114c, lower surface engaging portion 104c may be arranged similar to lower surface engaging portion 114c, and/or any combination thereof, among other possibilities.

As also illustrated in FIG. 1A, as measured from a plane that bisects the shimming device 100 along a longitudinal axis defined by legend 102, each pair of protrusions is a different height than the other pairs of protrusions, as measured in a direction defined by the vertical axis defined by legend 102. As illustrated in FIG. 1A, the sixth pair of protrusions 114a and 114b has a smaller height than the fifth pair of protrusions 112a and 112b, the fifth pair of protrusions 112a and 112b has a smaller height than the fourth pair of protrusions 110a and 110b, the fourth pair of protrusions 110a and 110b has a smaller height than the third pair of protrusions 108a and 108b, the third pair of protrusions 108a and 108b has a smaller height than the second pair of protrusions 106a and 106b, and the second pair of protrusions 106a and 106b has a smaller height than the first pair of protrusions 104a and 104b. In this regard, as illustrated in FIG. 1A, the pairs of protrusions are illustrated as six pairs of coupled steps, as each pair gets progressively larger as you move along the longitudinal axis from the sixth pair of protrusions 114a and 114b to the first pair of protrusions 104a and 104b.

In a further aspect, as illustrated in FIG. 1A, all of the first lower surface engaging portion 104c, the third lower surface engaging portion 108c, a fourth lower surface engaging portion 110c, a fifth lower surface engaging portion 112c, a sixth lower surface engaging portion 114c have the same height, as measured from a plane that bisects the shimming device 100 along the longitudinal axis and in a direction defined by the vertical axis. Furthermore, although the heights of the protrusions and their respective lower surface engaging portions are illustrated in a specific arrangement in FIG. 1A, many other arrangements are possible, including: different heights between each of the protrusions and/or some of the protrusions, different heights between each of the lower surface engaging portions and/or some of the lower surface engaging portions, and/or any combination thereof, among other possibilities.

As also illustrated in FIG. 1A, each pair of protrusions on the first side of the shimming device 100 has a corresponding pair of protrusions on a second side, which, as illustrated in FIG. 1A, is opposite the first side. As illustrated in FIG. 1A, the first pair of protrusions 104a and 104b is aligned in with first protrusion 120a of a seventh pair of protrusions, the second pair of protrusions 106a and 106b is aligned in with first protrusion 122a of an eighth pair of protrusions, the third pair of protrusions 108a and 108b is aligned in with first protrusion 124a of a ninth pair of protrusions, the fourth pair of protrusions 110a and 110b is aligned in with first protrusion 126a of a tenth pair of protrusions, the fifth pair of protrusions 112a and 112b is aligned in with first protrusion 128a of an eleventh pair of protrusions, and the sixth pair of protrusions 114a and 114b is aligned in with first protrusion 130a of a twelfth pair of protrusions. Furthermore, although the alignment of the protrusions and their respective lower surface engaging portions versus protrusions and their respective lower surface engaging portions on the opposite side of the shimming device are illustrated in a specific arrangement in FIG. 1A, many other arrangements are possible, including that one or more of the protrusions and their respective lower surface engaging portions may be misaligned with one or more respective protrusions and their respective lower surface engaging portions on the opposite side of the shimming device, among other possibilities.

Turning to FIG. 1B, in example embodiments, the shimming device 100 of FIG. 1A is shown from an isometric view that is rotated 180 degrees from the isometric view of shimming device 100 illustrated in FIG. 1A, as measured along the longitudinal axis of FIGS. 1A and 1B. As illustrated in FIG. 1B, shimming device includes seventh pair of protrusions 120a and 120b, an eighth pair of protrusions 122a and 122b, a ninth pair of protrusions 124a and 124b, a tenth pair of protrusions 126a and 126b, an eleventh pair of protrusions 128a and 128b, and a twelfth pair of protrusions 130a and 130b.

In the example embodiment illustrated in FIG. 1B, a second side of the shimming device 100 (identified by second identifier 132) includes six pairs of coupled protrusions, each of which has the same lower surface engaging portion disposed between the respective pairs of coupled protrusions. As shown in FIG. 1B, seventh lower surface engaging portion 120c is disposed between all of the seventh, eighth, ninth, tenth, eleventh, and twelfth pairs of protrusions and is shown in FIG. 1B as one solid contiguous surface (excluding the recessed created by second identifier 132). As also illustrated in FIG. 1B, although not specifically enumerated, space channels are illustrated between pairs of protrusions and other pairs of protrusions. In alternative embodiments, one or more of the seventh, eighth, ninth, tenth, eleventh, and twelfth pairs of protrusions may be arranged similarly to first, second, third, fourth, fifth, and/or sixth pairs of protrusions illustrated in FIG. 1A (and described in further detail above).

As also illustrated in FIG. 1i, as measured from a plane that bisects the shimming device 100 along a longitudinal axis defined by legend 102, each pair of protrusions is a different height than the other pairs of protrusions, as measured in a direction defined by the vertical axis defined by legend 102, and present the same stepping arrangement as illustrated in FIG. 1A. As further illustrated in FIG. 1i, as measured from a plane that bisects the shimming device 100 along the longitudinal axis and in a direction defined by the vertical axis, the seventh pair of protrusions 120a and 120b has the same height as the first pair of protrusions 104a and 104b, the eighth pair of protrusions 122a and 122b has the same height as the second pair of protrusions 106a and 106b, the ninth pair of protrusions 124a and 124b has the same height as the third pair of protrusions 108a and 108b, the tenth pair of protrusions 126a and 126b has the same height as the fourth pair of protrusions 110a and 110b, the eleventh pair of protrusions 128a and 128b has the same height as the fifth pair of protrusions 112a and 112b, and the twelfth pair of protrusions 130a and 130b has the same height as the sixth pair of protrusions 114a and 114b. In this regard, as illustrated in FIG. 1B, the pairs of protrusions are illustrated as six pairs of coupled steps, as each pair gets progressively larger as you move along the longitudinal axis from the twelfth pair of protrusions 130a and 130b to the seventh pair of protrusions 120a and 120b. In alternative embodiments, one or more of the seventh, eighth, ninth, tenth, eleventh, and twelfth pairs of protrusions may have a different height than one or more of the first, second, third, fourth, fifth, and/or sixth pairs of protrusions illustrated in FIG. 1A (and described in further detail above).

In a further aspect, as illustrated in FIG. 1B, because all of the first lower surface engaging portion 104c, the third lower surface engaging portion 108c, a fourth lower surface engaging portion 110c, a fifth lower surface engaging portion 112c, a sixth lower surface engaging portion 114c have the same height, the seventh lower surface engaging portion 120c has a smaller height compared to the first lower surface engaging portion 104c, the third lower surface engaging portion 108c, a fourth lower surface engaging portion 110c, a fifth lower surface engaging portion 112c, a sixth lower surface engaging portion 114c, as measured from a plane that bisects the shimming device 100 along the longitudinal axis and in a direction defined by the vertical axis.

As shown in FIGS. 1A and 1B, in example embodiments, whenever a pair of the coupled protrusions illustrated by first pair of protrusions 104a and 104b, a second pair of protrusions 106a and 106b, a third pair of protrusions 108a and 108b, a fourth pair of protrusions 110a and 110b, a fifth pair of protrusions 112a and 112b, and a sixth pair of protrusions 114a and 114b engages a first surface of a plurality of surfaces, a portion of seventh lower surface engaging portion 120c will engage a second surface of the plurality of surfaces. In a further aspect, whenever the shimming device 100 is inverted, whenever a pair of the coupled protrusions illustrated by seventh pair of protrusions 120a and 120b, eighth pair of protrusions 122a and 122b, ninth pair of protrusions 124a and 124b, tenth pair of protrusions 126a and 126b, eleventh pair of protrusions 128a and 128b, and twelfth pair of protrusions 130a and 130b engages the first surface of the plurality of surfaces, one of the first lower surface engaging portion 104c, third lower surface engaging portion 108c, fourth lower surface engaging portion 110c, fifth lower surface engaging portion 112c, sixth lower surface engaging portion 114c will engage the second surface of the plurality of surfaces. In this regard, in the example embodiment illustrated in FIGS. 1A-1B, shimming device 100 provide twelve different shimming heights that can be utilized simply by inverting the shimming device (six progressive steps on one side and six progressive steps on the other side). Furthermore, as illustrated in FIGS. 1A and 1, the surfaces of first pair of protrusions 104a and 104b, a second pair of protrusions 106a and 106b, a third pair of protrusions 108a and 108b, a fourth pair of protrusions 110a and 110b, a fifth pair of protrusions 112a and 112b, and a sixth pair of protrusions 114a, seventh pair of protrusions 120a and 120b, eighth pair of protrusions 122a and 122b, ninth pair of protrusions 124a and 124b, tenth pair of protrusions 126a and 126b, eleventh pair of protrusions 128a and 128b, and twelfth pair of protrusions 130a and 130b, first lower surface engaging portion 104c, third lower surface engaging portion 108c, fourth lower surface engaging portion 110c, fifth lower surface engaging portion 112c, sixth lower surface engaging portion 114c, and seventh lower surface engaging portion 120c, that would engage the first and/or second surface of the plurality of surfaces are all illustrated as flat or substantially flat.

Turning to FIG. 1C, in example embodiments, the shimming device 100 of FIGS. 1A-1B is shown from an isometric environmental view of the shimming device operating in an example environment. As shown in FIG. 1C, shimming device 100 is illustrated as inserted between various components of an imaging device. In FIG. 1C, a first portion of shimming device 100 is engaged with a first surface 134 of a first component by being inserted into a space proximate to the first surface 134 and therefore making contact with the first surface 134. In FIG. 1C, a second portion of shimming device 100 is engaged with a second surface 136 of a second component by being inserted into a space proximate to the second surface 136 and therefore making contact with the second surface 136. As illustrated in FIG. 1C, as shimming device 100 is adjusted (e.g., moved in and out of the space between the two components), one or more of the first and second components will be adjusted in space, as will any components that are connected to the first and second components. In a further aspect, an additional shimming device 138 may be disposed be other components of the imaging device and adjust those components in one or more other directions. In this regard, multiple shimming devices may be used in the same imaging device to provide consistent, repeatable adjustments for any number of components in any number of directions. Other examples are possible.

Turning to FIG. 1D, in example embodiments, the shimming device 100 of FIGS. 1A-1C is shown from side view, with the first identifier 118 and the second identifier 132 illustrated for reference.

Turning to FIG. 1E, in example embodiments, the shimming device 100 of FIGS. 1A-1D is shown from an alternate side view.

Turning to FIG. 1F, in example embodiments, the shimming device 100 of FIGS. 1A-1E is shown from an alternate side view.

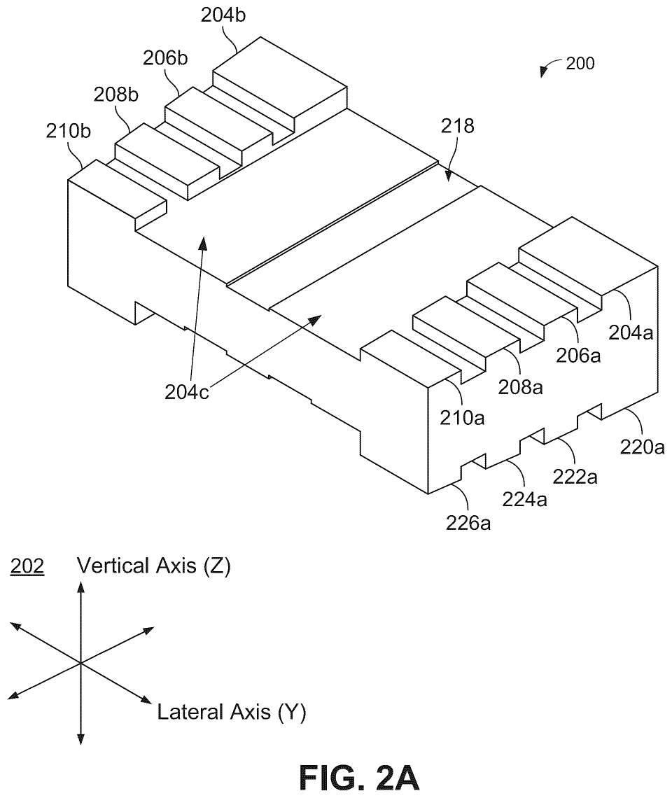

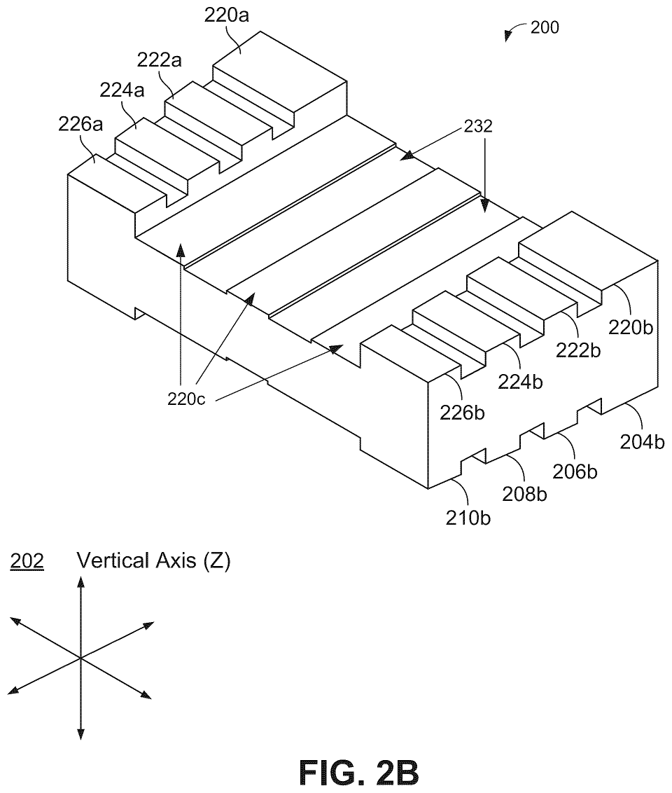

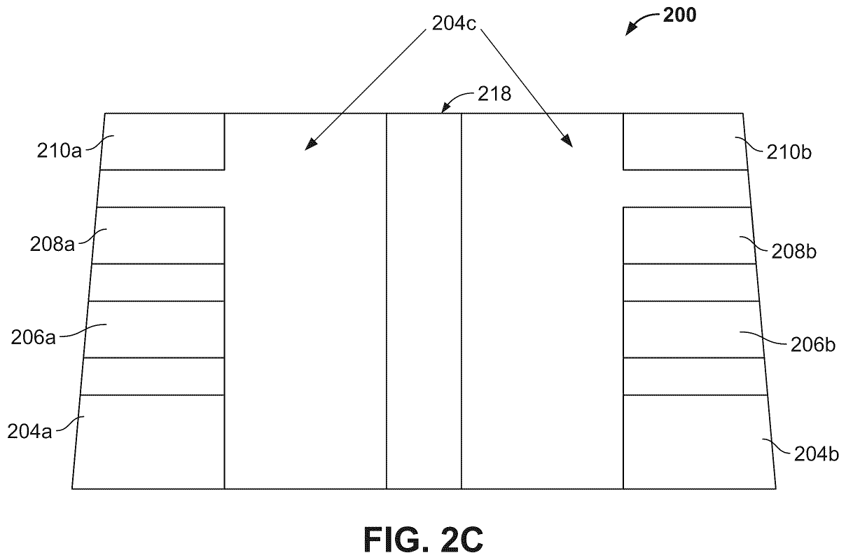

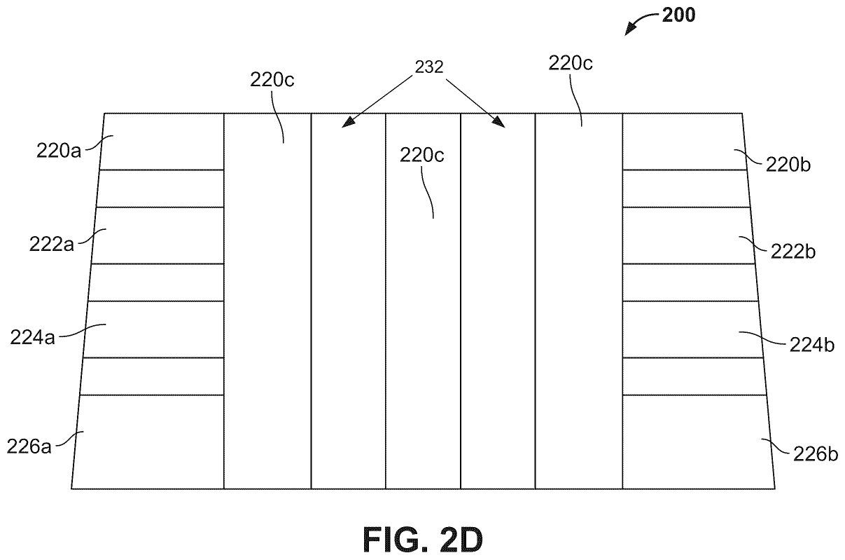

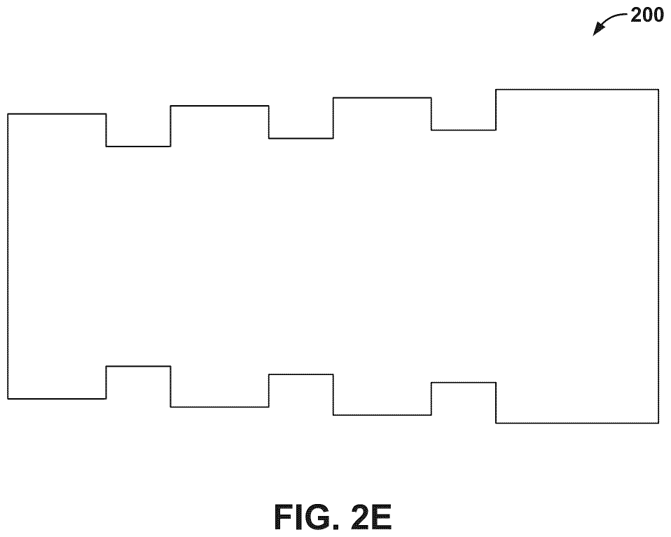

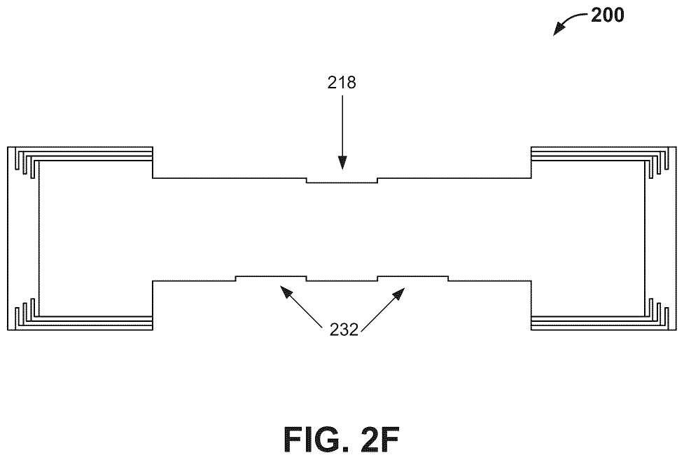

Now referring to FIGS. 2A-2F, FIGS. 2A-2F illustrate an example shimming device 200 that is substantially the same as the shimming device 100 shown in FIGS. 1A-1F. As illustrated in FIG. 2A, an isometric view of shimming device 200 is illustrated, with the relative direction and orientation of the shimming device 200 defined by legend 202 (which illustrates a vertical axis (z), a longitudinal axis (x), and lateral axis (y)). As illustrated in FIG. 2A, in example embodiments, the shimming device 200 includes first pair of protrusions 204a and 204b, a second pair of protrusions 206a and 206b, a third pair of protrusions 208a and 208b, and a fourth pair of protrusions 210a and 210b, a first lower surface engaging portion 204c, and a first identifier 218. In some examples, the first identifier 218 is an ornamental feature providing an indication of the orientation of the shimming device 200, for example, to an operator. As shown in FIG. 2B, in some example configurations, the first identifier 218 may extend from between the first pair of protrusions 204a and 204b to between the fourth pair of protrusions 210a and 210b.

As shown in FIG. 2A, the first lower surface engaging portion 204c is disposed between all of the first, second, third, and fourth pairs of protrusions and is shown in FIG. 2A as one solid contiguous surface (excluding the recess created by first identifier 218). In example embodiments, the first lower surface engaging portion is a same height across a length of the first lower surface engaging portion from a longitudinal axis of the shimming device.

Turning to FIG. 2B, in example embodiments, the shimming device 200 of FIG. 2A is shown from an isometric view that is rotated 180 degrees from the isometric view of shimming device 200 illustrated in FIG. 2A, as measured along the longitudinal axis of FIGS. 2A and 2B. As illustrated in FIG. 2B, shimming device includes a fifth pair of protrusions 220a and 220b, a sixth pair of protrusions 222a and 222b, a seventh pair of protrusions 224a and 224b, an eighth pair of protrusions 226a and 226b, a second lower engaging surface 220c, and a second identifier 232. In some examples, the second identifier 232 is an ornamental feature providing an indication of the orientation of the shimming device 200, for example, to an operator. As shown in FIG. 2B, in some example configurations, the second identifier 232 may extend from between the fifth pair of protrusions 220a and 220b to between the eighth pair of protrusions 226a and 226b.

As shown in FIG. 2B, second lower surface engaging portion 220c is disposed between all of the fifth, sixth, seventh, and eighth pairs of protrusions and is shown in FIG. 2B as one solid contiguous surface (excluding the recess created by second identifier 232).

Turning to FIG. 2C, in example embodiments, the shimming device 200 of FIGS. 2A-2B is shown from a top view, with the first identifier 218 illustrated for reference.

Turning to FIG. 2D, in example embodiments, the shimming device 200 of FIGS. 2A-2C is shown from a bottom view, with the second identifier 232 illustrated for reference.

Turning to FIG. 2E, in example embodiments, the shimming device 200 of FIGS. 2A-2D is shown from a side view.

Turning to FIG. 2F, in example embodiments, the shimming device 200 of FIGS. 2A-2E is shown from an alternate side view, with the first identifier 218 and the second identifier 232 illustrated for reference.

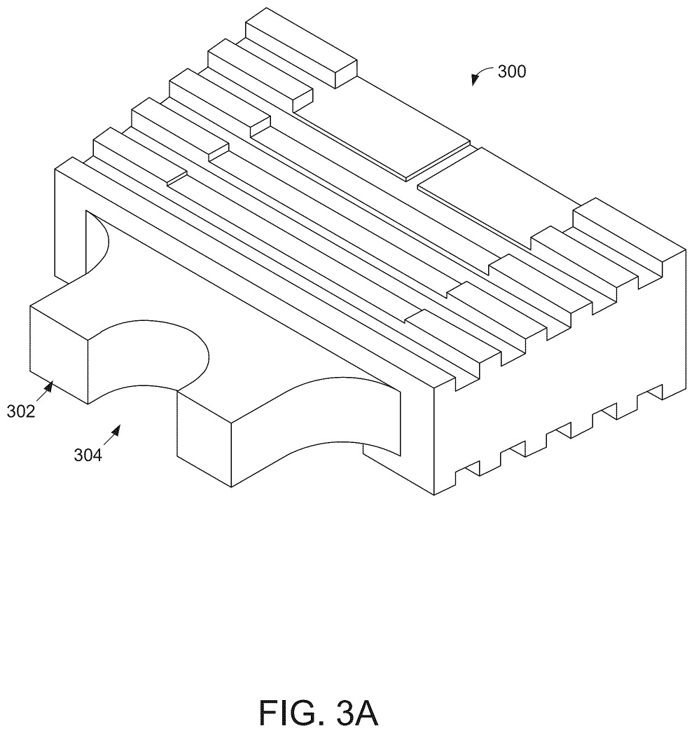

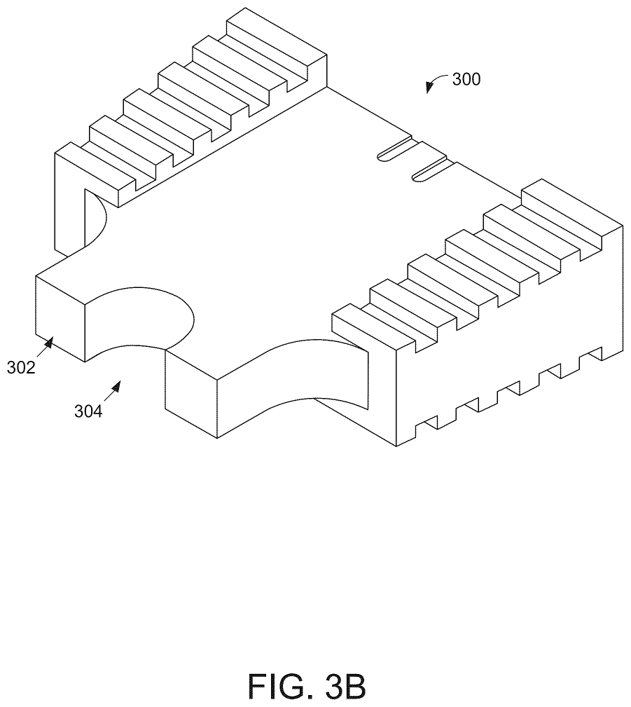

Now referring to FIGS. 3A-3B, FIGS. 3A-3B illustrate an example shimming device 300 that is substantially the same as shimming device 100 (illustrated in FIGS. 1A-1F) and shimming device 200 (illustrated in FIGS. 2A-2F). As illustrated in FIG. 3A, an isometric view of shimming device 300 is illustrated, with the addition of a handle 302 and a handle recess 304. In examples, one or more features of the handle 302 and/or handle recess 304 may be ornamental and/or functional. For example, one or more portions of handle 302 and/or handle recess 304 may be designed to integrate with one or more components of the imaging device (e.g., a fastener mechanism). Other examples are possible.

Turning to FIG. 3B, in example embodiments, the shimming device 300 of FIG. 3A is shown from an isometric view that is rotated 180 degrees from the isometric view of shimming device 300 illustrated in FIG. 3A. Other examples are possible.

### EXAMPLE METHODS AND ASPECTS

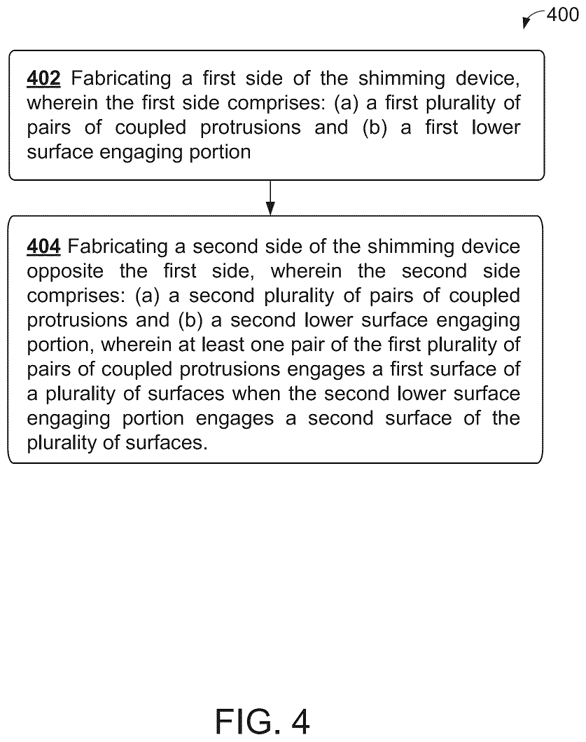

FIG. 3 shows a flowchart of an example of a method 400 for manufacturing a shimming device for engaging a plurality of surfaces, according to an example implementation. The method 400 shown in FIG. 4 presents an example of a method that could be used with the shimming device 100, shimming device 200, and shimming device 400 shown in FIG. 1A-3B, for example. Further, devices or systems may be used or configured to perform logical functions presented in FIG. 4. In other examples, components of the devices and/or systems may be arranged to be adapted to, capable of, or suited for performing the functions, such as when operated in a specific manner. Method 400 may include one or more operations, functions, or actions as illustrated by one or more of blocks 402-404. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 402, method 400 involves fabricating a first side of the shimming device, wherein the first side comprises: a first plurality of pairs of coupled protrusions; and a first lower surface engaging portion, wherein the first lower surface engaging portion is disposed between at least one pair of coupled protrusions of the first plurality of pairs of coupled protrusions.

At block 404, method 400 involves fabricating a second side of the shimming device opposite the first side, wherein the second side comprises: a second plurality of pairs of coupled protrusions; and a second lower surface engaging portion, wherein the second lower surface engaging portion is disposed between at least one pair of coupled protrusions of the second plurality of pairs of coupled protrusions, and wherein at least one pair of the first plurality of pairs of coupled protrusions engages a first surface of the plurality of surfaces when the second lower surface engaging portion engages a second surface of the plurality of surfaces.

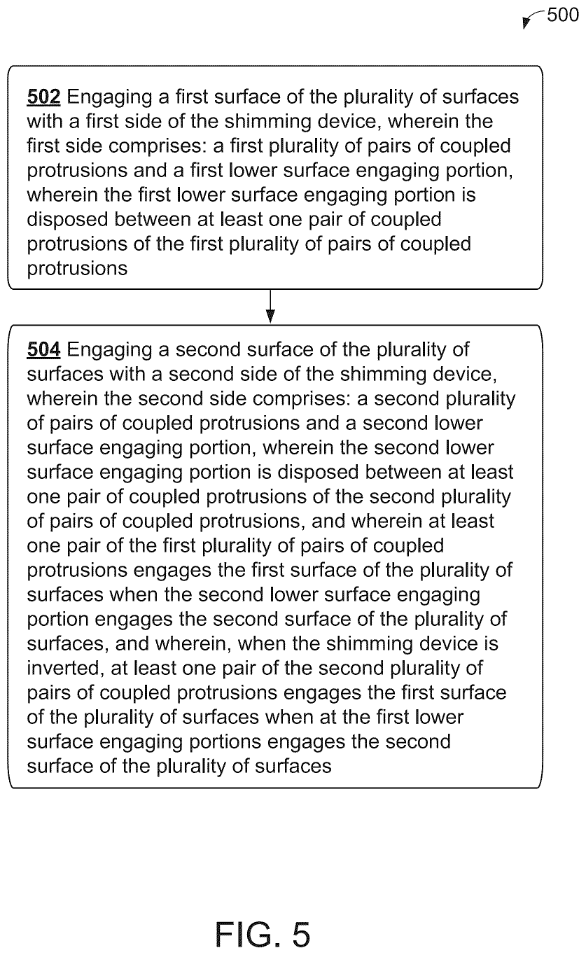

FIG. 4 shows a flowchart of an example of a method 500 for using a shimming device to engage a plurality of surfaces, according to an example implementation. The method 500 shown in FIG. 5 presents an example of a method that could be used with the shimming device 100 and shimming device 200 shown in FIG. 1A-3B, for example. Further, devices or systems may be used or configured to perform logical functions presented in FIG. 5. In other examples, components of the devices and/or systems may be arranged to be adapted to, capable of, or suited for performing the functions, such as when operated in a specific manner. Method 500 may include one or more operations, functions, or actions as illustrated by one or more of blocks 502-504. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 502, method 500 involves engaging a first surface of the plurality of surfaces with a first side of the shimming device, wherein the first side comprises: a first plurality of pairs of coupled protrusions and a first lower surface engaging portion, wherein the first lower surface engaging portion is disposed between at least one pair of coupled protrusions of the first plurality of pairs of coupled protrusions.

At block 504, method 500 involves engaging a second surface of the plurality of surfaces with a second side of the shimming device, wherein the second side comprises: a second plurality of pairs of coupled protrusions and a second lower surface engaging portion, wherein the second lower surface engaging portion is disposed between at least one pair of coupled protrusions of the second plurality of pairs of coupled protrusions, and wherein at least one pair of the first plurality of pairs of coupled protrusions engages the first surface of the plurality of surfaces when the second lower surface engaging portion engages the second surface of the plurality of surfaces, and wherein, when the shimming device is inverted, at least one pair of the second plurality of pairs of coupled protrusions engages the first surface of the plurality of surfaces when the first lower surface engaging portion engages the second surface of the plurality of surfaces.

In one aspect, in example embodiments, a shimming device comprising a first side and a second side is disclosed. In example embodiments, the first side includes a first plurality of pairs of coupled protrusions and a first lower surface engaging portion, wherein the first lower surface engaging portion is disposed between at least one pair of coupled protrusions of the first plurality of pairs of coupled protrusions. In example embodiments, the second side is opposite the first side and includes a second plurality of pairs of coupled protrusions and a second lower surface engaging portion, wherein the second plurality of lower surface engaging portion is disposed between at least one pair of coupled protrusions of the second plurality of pairs of coupled protrusions. In example embodiments, at least one pair of the first plurality of pairs of coupled protrusions engages a first surface of the plurality of surfaces when the second lower surface engaging portion engages a second surface of the plurality of surfaces. In another aspect, in examples, when the shimming device is inverted, at least one pair of the second plurality of pairs of coupled protrusions engages the first surface of the plurality of surfaces when the first lower surface engaging portions engages the second surface of the plurality of surfaces.

In one aspect, in examples, each pair of coupled protrusion of the first plurality of pairs of coupled protrusions is aligned with a respective pair of coupled protrusion of the second plurality of pairs of coupled protrusions. In another aspect, in examples, the first lower surface engaging portion is disposed between all of the first plurality of pairs of coupled protrusions, and wherein the second lower surface engaging portion is disposed between all of the second plurality of pairs of coupled protrusions. In another aspect, in examples, the first plurality of pairs of coupled protrusions comprises a first plurality of pairs of coupled steps, and wherein each pair of coupled steps of the first plurality of pairs of coupled steps is a different height from a longitudinal axis of the shimming device. In another aspect, in examples, the first lower surface engaging portion is disposed between at least one pair of coupled steps of the first plurality of pairs of coupled steps, and wherein the first lower surface engaging portion is a same height across a length of the first lower surface engaging portion from a longitudinal axis of the shimming device. In another aspect, in examples, the second plurality of pairs of coupled protrusions comprises a second plurality of pairs of coupled steps, and wherein each pair of coupled steps of the second plurality of pairs of coupled steps is a different height from a longitudinal axis of the shimming device, and wherein each pair of coupled steps of the first plurality of pairs of coupled steps is aligned with a respective pair of coupled steps of the second plurality of pairs of coupled steps.

In another aspect, in examples, wherein the second lower surface engaging portion is disposed between at least one pair of coupled steps of the second plurality of pairs of coupled steps, and wherein the second lower surface engaging portion is a same height across a length of the second lower surface engaging portion from the longitudinal axis of the shimming device. In another aspect, in examples, the height of the first lower surface engaging portion is different than the height of the second lower surface engaging portion.

In another aspect, in examples, the first plurality of pairs of coupled steps comprises a first pair of coupled steps and a second pair of coupled steps, and wherein the shimming device further comprises a spacer channel disposed between the first pair of coupled steps and the second pair of coupled steps.

In one aspect, in example embodiments, one or more surfaces of the at least one pair of the first plurality of pairs of coupled protrusions that engages the first surface of the plurality of surfaces is substantially flat. In another aspect, in examples, one or more surfaces of the second lower surface engaging portion that engages the second surface of the plurality of surfaces is substantially flat. In another aspect, in examples, at least one of the first plurality of lower surface engaging portions and the second plurality of lower surface engaging portions comprises a single surface.

In one aspect, in example embodiments, the shimming device further comprises a handle. In another aspect, in examples, the handle is configured to interface with a fastener mechanism. In one aspect, in example embodiments, the shimming device further comprises an indicator of at least one of the first side and the second side. In another aspect, in examples, comprises a metal alloy, including a stainless steel alloy.

The singular forms of the articles “a,” “an,” and “the” include plural references unless the context clearly indicates otherwise. Further, the above detailed description describes various features and functions of the disclosed systems, devices, and methods with reference to the accompanying Figures. In the Figures, similar symbols typically identify similar components, unless context dictates otherwise. The illustrative embodiments described in the detailed description, Figures, and claims are not meant to be limiting. Other embodiments can be utilized, and other changes can be made, without departing from the scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A shimming device for engaging a plurality of surfaces, wherein the shimming device comprises:
a first side comprising:
a first plurality of pairs of coupled protrusions; and
a first lower surface engaging portion, wherein the first lower surface engaging portion is disposed between at least one pair of coupled protrusions of the first plurality of pairs of coupled protrusions; and
a second side opposite the first side comprising:
a second plurality of pairs of coupled protrusions; and
a second lower surface engaging portion, wherein the second lower surface engaging portion is disposed between at least one pair of coupled protrusions of the second plurality of pairs of coupled protrusions, and wherein at least one pair of the first plurality of pairs of coupled protrusions engages a first surface of the plurality of surfaces when the second lower surface engaging portion engages a second surface of the plurality of surfaces.

2. The shimming device of claim 1, wherein each pair of coupled protrusions of the first plurality of pairs of coupled protrusions is aligned with a respective pair of coupled protrusions of the second plurality of pairs of coupled protrusions.

3. The shimming device of claim 1, wherein the first lower surface engaging portion is disposed between all of the first plurality of pairs of coupled protrusions, and wherein the second lower surface engaging portion is disposed between all of the second plurality of pairs of coupled protrusions.

4. The shimming device of claim 1, wherein the first plurality of pairs of coupled protrusions comprises a first plurality of pairs of coupled steps, and wherein each pair of coupled steps of the first plurality of pairs of coupled steps is a different height from a longitudinal axis of the shimming device.

5. The shimming device of claim 4, wherein the first lower surface engaging portion is disposed between at least one pair of coupled steps of the first plurality of pairs of coupled steps, and wherein the first lower surface engaging portion is a same height across a length of the first lower surface engaging portion from a longitudinal axis of the shimming device.

6. The shimming device of claim 5, wherein the second plurality of pairs of coupled protrusions comprises a second plurality of pairs of coupled steps, and wherein each pair of coupled steps of the second plurality of pairs of coupled steps is a different height from a longitudinal axis of the shimming device, and wherein each pair of coupled steps of the first plurality of pairs of coupled steps is aligned with a respective pair of coupled steps of the second plurality of pairs of coupled steps.

7. The shimming device of claim 6, wherein the second lower surface engaging portion is disposed between at least one pair of coupled steps of the second plurality of pairs of coupled steps, and wherein the second lower surface engaging portion is a same height across a length of the second lower surface engaging portion from the longitudinal axis of the shimming device.

8. The shimming device of claim 7, wherein a height of the first lower surface engaging portion is different than a height of the second lower surface engaging portion.

9. The shimming device of claim 8, wherein the first plurality of pairs of coupled steps comprises a first pair of coupled steps and a second pair of coupled steps, and wherein the shimming device further comprises a spacer channel disposed between the first pair of coupled steps and the second pair of coupled steps.

10. The shimming device of claim 1, wherein, when the shimming device is inverted, at least one pair of the second plurality of pairs of coupled protrusions engages the first surface of the plurality of surfaces when at the first lower surface engaging portion engages the second surface of the plurality of surfaces

11. The shimming device of claim 1, wherein one or more surfaces of the at least one pair of the first plurality of pairs of coupled protrusions that engages the first surface of the plurality of surfaces is substantially flat.

12. The shimming device of claim 1, wherein one or more surfaces of the second plurality of lower surface engaging portion that engages the second surface of the plurality of surfaces is substantially flat.

13. The shimming device of claim 1, wherein at least one of the first lower surface engaging portion and the second lower surface engaging portion comprises a single surface.

14. The shimming device of claim 1, wherein the shimming device further comprises a handle.

15. The shimming device of claim 13, wherein the handle is configured to interface with a fastener mechanism.

16. The shimming device of claim 1, wherein the shimming device further comprises an indicator of at least one of the first side and the second side.

17. The shimming device of claim 1, wherein the shimming device comprises a metal alloy.

18. The shimming device of claim 17, wherein the metal alloy comprises a stainless steel alloy.

19. A shimming device for engaging a plurality of surfaces, wherein the shimming device comprises:
a first side comprising:
a first plurality of pairs of coupled protrusions; and
a first plurality of lower surface engaging portions, wherein each lower surface engaging portion of the first plurality of lower surface engaging portions is disposed between a respective pair of coupled protrusions of the first plurality of pairs of coupled protrusions; and
a second side opposite the first side comprising:
a second plurality of pairs of coupled protrusions; and
a second plurality of lower surface engaging portions, wherein each lower surface engaging portion of the second plurality of lower surface engaging portions is disposed between a respective pair of coupled protrusions of the second plurality of pairs of coupled protrusions, and wherein at least one pair of the first plurality of pairs of coupled protrusions engages a first surface of the plurality of surfaces when at least one lower surface engaging portion of the second plurality of lower surface engaging portions engages a second surface of the plurality of surfaces, and wherein, when the shimming device is inverted, at least one pair of the second plurality of pairs of coupled protrusions engages the first surface of the plurality of surfaces when at least one lower surface engaging portion of the first plurality of lower surface engaging portions engages the second surface of the plurality of surfaces.

20. A method for engaging a plurality of surfaces with a shimming device, wherein the method comprises:
engaging a first surface of the plurality of surfaces with a first side of the shimming device, wherein the first side comprises:
a first plurality of pairs of coupled protrusions; and
a first lower surface engaging portion, wherein the first lower surface engaging portion is disposed between at least one pair of coupled protrusions of the first plurality of pairs of coupled protrusions; and
engaging a second surface of the plurality of surfaces with a second side of the shimming device, wherein the second side comprises:
a second plurality of pairs of coupled protrusions; and
a second lower surface engaging portion, wherein the second lower surface engaging portion is disposed between at least one pair of coupled protrusions of the second plurality of pairs of coupled protrusions, and wherein at least one pair of the first plurality of pairs of coupled protrusions engages the first surface of the plurality of surfaces when the second lower surface engaging portion engages the second surface of the plurality of surfaces, and wherein, when the shimming device is inverted, at least one pair of the second plurality of pairs of coupled protrusions engages the first surface of the plurality of surfaces when the first lower surface engaging portion engages the second surface of the plurality of surfaces.
